(19) United States
(12) Patent Application Publication
(10) Pub. No.: US 2011/0283866 A1
(43) Pub. Date: Nov. 24, 2011

(54) COMPUTER BASED SYSTEM FOR TEACHING OF PLAYING MUSIC

(75) Inventor: Brendan Hogan, Queensland (AU)

(73) Assignee: Musiah Ltd, Hamilton (BM)

(21) Appl. No.: 13/145,598

(22) PCT Filed: Jan. 21, 2010
(86) PCT No.: PCT/AU2010/000057

§ 371 Date: Aug. 4, 2011

(30) Foreign Application Priority Data
Jan. 21, 2009 (AU) 2009900226

(51) Int. Cl. G09B 15/00

(52) U.S. Cl. 84/470 R

(57) ABSTRACT

A method and system for guiding a student to learn how to play a musical instrument, the musical instrument is associated with a learner terminal which includes at least one input device and at least one output device, reference data; and a processor device; test data can be upon instruction by the processor device be submitted to the learner terminal by the student with either the at least one input device or the musical instrument; the test data is automatically processed by the processor device by analysing the at least referencing the test data to the reference data so that a response can be communicated by the processor device to the student trough the at least one output device.

### FIELD OF THE INVENTION

This invention relates to a music education system and in particular to a system for teaching instrumental music but is not limited to such. Whilst the invention may be applied to music education in general, for convenience sake it shall be described herein in terms of piano teaching.

### BACKGROUND TO THE INVENTION

It is generally a standard teaching of instruments to have an individual or small group attendance with a professional teacher of music. However such approaches are substantially expensive and rely on the coordination of availability with the student, the professional teacher and often the student's parent or guardian to provide suitable transport. Therefore, it is beneficial to provide at least some elements of teaching of instruments in a manner that allows for individual supervision every day, adequate feedback and a method of learning that ensures the child is interested and confident to continue.

Further, lessons with professional teachers are often 1 week apart. Frequently a disadvantage arises where professional teachers conduct lessons instructing the students to play the whole piece of music in the left and right hand, but not together. The child must wait until the following week before learning to play the piece in both hands. The student is therefore not adequately tested and can lose interest in their instrument. Additionally, students are rarely taught what methods to utilise when practicing between lessons. The child therefore develops inefficient and ineffective practice habits.

However teaching methods by software programs to date have merely been a schedule determining structure so that instructions are given to the student to undertake certain tasks and then, on completion, move onto other tasks. Such systems have no manner of actual teaching or monitoring. They offer limited or no interactivity and are unable to provide feedback and guidance to the student.

### SUMMARY OF THE INVENTION

Accordingly, it is an object of the present invention to overcome or substantially ameliorate the disadvantages of the prior art by providing an improved music education system which provides a virtual tutor which can guide and assist a student to learn a piece of music.

One example of the invention generally provides a music education system which includes a learner terminal through which a student is capable of learning to play a musical instrument; the learner terminal includes at least one input device with which the student is capable of generating test data; a processor device which is capable of receiving the test data from the student; and at least one output device with which the processor device is capable of communicating with the student; the processor device automatically analysis the test data relative to at least a portion of a reference data accessible to the processor device; and wherein the analysis of the test data allows the processor device to select an appropriate response which is communicated to the student as output through the at least one output device to assist the student in learning how to play the musical instrument.

In one example the invention provides a music education system for aiding a student to learn how to play a musical instrument; the music education system includes a learner terminal having at least one input device and an instrument device both of which are operable by the student to input test data into the learner terminal; reference data; a processor device which receives the test data from the student and which automatically analyses the test data with the reference data to produce a result output; and at least one output device through which the response output is communicated to the student; the result output is selected by the processor device to aid the student learning how to play the musical instrument; and wherein the result output is communicated to the student through the at least one output device.

The music education system assists the student in mastering the instrument device or music instrument by providing guidance through a series of response or result outputs. Learning a musical instrument is often a difficult task and might take some time and be quite laborious at times. The music education system is designed to make the learning experience as appealing and pleasurable as possible to the student thereby increasing the likelihood of the student continuing learning the particular musical instrument. For example, the musical education system incorporates a story line with an associated credit system so that the student could be enticed to do his or her utmost to score as best as possible when using the system. In doing so the student will increase the credits awarded to the student when using the music education system which may increase the overall experience of the student using the music education system. This may assist the student in learning the musical instrument.

The purpose of the learner terminal is to provide an interface for the student through which the student can receive guidance or instructions when learning to play the musical instrument of its choice. To this end the learner terminal can be of any appropriate digital means such as a personal computer or the like.

The music education system has a number of different steps which guides the user during the learning process. Consequently, during certain steps the student may be asked to input test data into the learner terminal, for example by choosing an option. The input device can therefore by any suitable instrument which will allow the user to make the selection and input the test data to the learner terminal. For example, the input device may be a keyboard or an optical device such as a mouse or a touch screen.

During other steps of the music education system the instrument device or musical instrument may be used to input test data, for example a segment of a piece of music played on the instrument, into the learner terminal. In one example of the invention the musical instrument is electrically connected to the learner terminal, for example via a universal serial bus connection or the like, so that a digital representation of the music played on the music instrument is electrically communicated as the test data to the learner terminal. In a further example of the invention, sound waves produced by the musical instrument can be converted using a suitable device, for example a microphone, into a digital signal. This digital signal can then be electrically communicated to the learner terminal so that the converted signal is submitted as the test signal for analysis by the processor device.

The processor device may use the reference data to determine whether the student, for example, answered correctly or played a particular segment of a piece of music correctly. In one example of the invention the reference data is stored on the learner terminal for ready reference by the processor device. In another example of the invention, the reference data is stored on a removable medium such as an optical disc, removable hard drive or the like. These mediums are then made available for access by the processor device by typically inserting the optical disc into a cdrom of the learner station or by connecting, electrically or wirelessly, the removable hard drive to the learner terminal.

In another example of the invention, the processor device may analyse and process the test data to determine whether the student may be struggling or finding certain aspects of the learning experience more difficult.

Typically this type of analysis is conducted in light of historical data, for example earlier student data or an assessment of what can be reasonably expected of a student having a certain skill set and musical experience.

For example, if the student is repeating certain sections more than a predetermined number of times (this figure may be selected from previous experience of teaching students or as a collective assessment of fellow students using the music education system), the response selected by the processor device to the analysis of the test data or the type of instructions given to the student may be altered.

In other words, the processor device, in situations in which the student, for example, has answered a particular question already three times incorrectly, the processor may then select to continue possibly in one of the following three ways.
Continue asking the same question until the student has answered the question correctly. Incorporated into this approach may be a slight variance in how the question is asked so that the question becomes more leading towards or suggestive of the correct answer.
Breaking the question down into smaller sections which, if each smaller section question is answered correctly, would lead the student to the correct answer of the initial question.
Change the format in which the question is delivered or asked. This can be done in a number of different ways such as by incorporating video, descriptive or explanatory text, audio, or the like. For example, the asking of the question may be preceded by a short video of a quick review of the particular section to which the question relates and which the student has completed earlier. In another example, the question may be asked in a classroom environment in which the lecturer engages in a short discussion surrounding the question. By watching this exchange of questions (possibly asked by the lecturer and by the fellow students) and answers (again possibly given by the lecturer and by the fellow students) the student may learn the answer. This learning of the answer may be achieved in a number of different ways and could be achieved by way of deduction or by way of receiving the answer from the classroom discussion. Which path is adopted may depend on the student and other factors such as a reasonable anticipation of the student's performance.

In a further example of the invention the learner terminal may communicate performance data collected of the student's performance using the music education system as an output to the remote terminal. A processor device or an administrator such as a teacher may then communicate back over the communication network updated or altered instructions as an input into the learner terminal. These updated or altered instructions are designed to further assist the student in learning how to play the musical instrument. For example, the update or altered instructions may be such that the questions are made more easily, or defined or asked in a different way, or may contain additional information surrounding each instruction which would assist the student in submitting test data as in input into the learner terminal which is of a high enough standard for the student to have complied with the instruction. In a further example the updated or altered instructions may be communicated to the learner terminal on medium which does not make use of the communication network with which the performance data was communicated to the remote terminal. For example, an email or an optical disc containing these instructions may be sent to the student. Alternatively, instructions may be communicated over the telephone to the student such in which the student is advised to change some settings of the system which will allow the system to adopt and adapted approach when assisting the student learn how to play the musical instrument.

In one example of the invention, the reference data may include instructions for the processor device to alter the instructions given to the student. In a further example of the invention, the learner terminal may include, as an output device, a communication device with which the learner terminal can transmit to a remote terminal part or all of the analysis of the test data submitted by the student. The remote terminal can then input data, in any appropriate form, to the learner terminal. Any appropriate communication network can be used to support the communications between the learner terminal and the remote terminal. For example, the communications network may be wireless. In one example of the invention the communication is conducted using access to the communication network which is provided by the student. In a further example the learner terminal may be assigned its own access to the communication network so that the learner terminal can communicate to the remote terminal at predetermined times or after having received input from the remote terminal.

In another example of the invention generally provides method for guiding a student to learn how to play a musical instrument on a digital device, the method including the steps of
a. providing on the digital device at least one instruction relating to the musical instrument for the student;
b. receiving test data from the student;
c. processing with the digital device the test data received from the student;
d. analyse the test data in relation to at least part of a reference data;
e. selecting with the digital device a response output based on the analysis of the test data so that the student is assisted in learning how to play the musical instrument; and
   automatically providing an response output which is accessible to the student.

The method may further include the steps during the analysis of the test data of
e. assigning an accuracy value to the test data in relation to the counterpart portion in the reference data, and
f. using the value to adjust the response output.

In a further example of the invention there is generally provided a method for guiding a student to learn how to play a musical instrument, the musical instrument is associated with a learner terminal which includes at least one input device and at least one output device, reference data; and a processor device; test data can be upon instruction by the processor device submitted to the learner terminal by the student with either the at least one input device or the musical instrument; the test data is automatically processed by the processor device by analysing the at least referencing the test data to the reference data so that a response can be determined by the processor device and communicated by the processor device to the student trough the at least one output device, the method including the steps of providing through the processor device on the at least one output device at least one instruction relating to the musical instrument for the student to perform; processing with the processor device the test data received from the student in answer to the instruction; selecting a response output based on the processing of the test data so that the student is assisted in learning how to play the musical instrument; and automatically communicating to the student the response output through the at least one output device.

The at least one instruction may be associated with a storyline which indicates to the student the progress which the student may have in learning to play the musical instrument. In another example of the invention the method includes a series of predefined instructions which are tied to various stages of the storyline. In this way the student is more likely to identify the objective of instructions so that the student can more readily understand the underlying purpose of completing the instruction. A scoring system may be incorporated into the method in addition to the storyline thereby to provide a grading or reward system which indicates to the student how well the student has completed each task. Additionally the scoring system could affect the options available to the student in the storyline which might entice the student to perform his best thereby to open those possibilities to the student in the storyline.

The method may include a number of predefined lessons and each lesson may have one or a number of questions. In one example of the invention the lessons are correlated with reaching certain stages, goals, destinations in the storyline so that as the student works through the lessons, the student progresses with the storyline. This correlation may provide to the student a reference network with which the student can readily appraise his or her progress through the storyline and what improvement has been made in his or her abilities or skills with the musical instrument.

Each lesson is structured to assist the student to master a particular aspect of playing the musical instrument. This aspect may relate to any number of skills which may be required to play the musical instrument. For example, these aspects include theory (notes, sheet music, etc), skills (dexterity when using the left hand, right hand, or both when playing the musical instrument), and practice in which the student has learnt how to play a particular piece of music on the musical instrument. To this end, the method may include, in each lesson, a revision step, a technique development step, a teaching and demonstrating step in which the processor device illustrates to the student certain aspects of playing the musical instrument, a piece learning step in which the student learns a particular piece of music covered in the lesson; and an audition step in which the piece of music is played in a number of different scenarios such in front of a classroom, the lectured, or a group.

In another example of the invention there is generally provided a music education system for use on a digital means which is capable of receiving an input from a student for analysis by the digital means to provide an output as a result of the analysis; the system provides a set of instructions to a student learning a musical instrument; and wherein upon receiving an input from the student the digital means automatically analysis the input thereby to provide further instructions to student as guidance in learning the musical instrument.

During the analysis the provided set of instructions can be reviewed; the automatic review includes a comparison of the received musical input and digitally compares is to the expected musical input thereby providing an analysis based on any one or more of:
a. accuracy of notes played;
b. accuracy of timing of notes;
c. accuracy of duration of notes;
d. accuracy of timbre;
e. depth of resonance;
f. overall accuracy; or
g. accuracy of specific portion of piece.

The scoring system may assign a different weight to different components of the test data submitted as input by the student. For example, more weight, in the form of a percentage, can be given to the accuracy of the note, followed by an equal weight, as a percentage, to timing and duration. The weight placed on timing and duration may be altered, by way of requiring less accuracy, for different students. For example, a beginner's piece might have a fairly generous tolerance for timing, whereas a more advanced piece would have tighter/narrower tolerances for timing. In other words, tolerances applied during the analysis of the test data can be adapted to suite particular circumstances.

The accuracy assessed can combine an assessment based within ranges together with an assessment determined by algorithm to provide a pseudo subjective assessment. For example, playing certain types of music often requires playing off the beat or with a lilt that is not mathematically correct but is artistically correct. However the review can be an objective assessment between the input from the student and a feedback from a recorded list of possible feedbacks. In this way an assessment is undertaken in comparison to a musical result and not merely a mathematical result.

The music education system can have a scheduler for constant input monitoring and feedback from a computer run by a learning program. The learning program can be improved or modified by internet review to a remote administrator following the analysis and review of the player's progress or grading.

The structure of the lesson can be defined and redefined according to feedback from the comparison of actual practise by the student. The structure of the lesson can be in accordance with:
a) predefined teaching technique of a defined topic
b) predefined teaching technique to remedy a detected flaw
c) predefined teaching technique to improve development.

The lesson structure can be a virtual lesson by use of a virtual instructor as a teacher or professor (or Musiah™) that introduces, corrects and advises on the scheduling and comparison. Therefore, the scheduling can include a display of theory or instructions prior to input from student. In one example of the invention in every lesson, a standard three-step lesson is followed by controlling the instructions. The three steps can be:
1. Revision (mostly of note reading/general knowledge) (30 secs to 3 mins)
2. Individual Pieces (20 mins)
3. Group Piece (relating to a child's individual piece) or alternative 3^{rd} activity

To define a pathway of the learning program a comparative storyline can be involved and displayed alongside the music instructions and review. Preferably the music instructions and review are intertwined by relevance to the virtual instructor as a teacher or professor (or Musiah™). Therefore any particular level or lesson can include a particular chapter or section of the story. This provides the benefit of allowing an awareness of musical progress and aims at all times by use of the students' pre-existing skill in understanding the progress of a storyline. Further a virtual game approach may provide an improvement in achieving musical goals.

The method of interpreting musical keyboard information from the input by the student may be by assessment of input of midi data by use of algorithms to provide an objective assessment.

There may be differentiating of feedback into correct/incorrect assessment and continuous assessment. For continuous assessment, the invention includes an assessment system by subdividing criteria into smaller parts that are scored as correct/incorrect assessments to provide an overall assessment and location of assessment found learning troubles.

In the music education system there may be a means of combining input from the student with input from one or more virtual inputs in sequenced timing. The input can be by stored inputs of a piece or with input from internet download.

In one form this group playing can be enhanced by visually displaying and providing virtual group lessons by simulating with virtual characters other parts of the story or music. This can include providing a graduated learning program that includes a corresponding graduated virtual storyline game.

Therefore the system offers students at home virtual group keyboard music lessons in the world's first virtual keyboard/piano lesson environment. The attention level offered is one-on-one and can be utilized at any time of the day, any day of the week.

The learning takes place and/or the songs are played with virtual friends/fellow students on the computer screen.

The music education system may provide an output from the automatic review of the received input in comparison to the provided set of instructions by providing one or more of the following:
(i) objective assessment or score;
(ii) comment generated from database in accordance with determined objective assessment or score;
(iii) graduation to higher level upon fulfilling requirements of prior level.

The system can provide a step review of a graduated learning program that reviews the assessed achievements and problems in a stage of the learning program and modifies the graduated learning program accordingly. This can include providing an online review and modification of the graduated learning program with the download of a modified program. In one level of the graduated learning program the first step can be left hand, second step right hand and third step both hands. There can be provisions for audio replay of selected assessed parts of the audio input.

The step review can be simulated by a corresponding storyline that provides a stepped set of goals. The storyline can include simulated adventures related to achieving reviewed fulfillment of procedural learning steps. Review can include a collection of objective assessments being simulated by virtual treasures which are reviewed at review sessions by replaying for what treasures are earned and what treasures were not found. In one form the simulated success to the final stages of the graduated learning program includes each stage providing partial information towards a final composition.

The system can use modified music teaching strategies with a virtual teacher or professor with predefined and modifiable methods including:
a) One-on-one attention
b) Private and comfortable environment
c) Accurate assessment of the child's level of playing
d) Pinpointing exactly the students areas of concern
e) Rewarding the child through appraisal and maintaining confidence and interest to continue playing.
f) Revision of pieces and note reading
g) Providing variety and continuous learning
h) The child learns at their own comfortable pace.

The review can include simulated communication with the instructor by communication from a virtual teacher or professor known as “Musiah Fandango™”. The virtual teacher or professor can provide output to the student including: providing explanations of concepts before level begins;
a) providing positive comments whilst playing
b) providing continual guidance by pointing to where the child is up to in the sheet music with a moving baton;
c) providing details of simulated story and goals to be achieved;
d) providing instructional comments and feedback on how to correct or improve performance.

In one form of the invention, by use of the system there is provided a new modified teaching method of Left Hand, Right Hand, Both Hands (LH, RH, BH)—one small segment at a time. Then repeat this process for each subsequent segment until the whole piece has been completed.

This can be by use of a REVEAL TECHNIQUE to show how both hands fit together. This is a technique that is used to help a student play with Both Hands (BH) for the very first time, but it can also be used whenever coordination difficulties arise, even in advanced pieces. The display shows the music but covers the notes on the sheet music and gradually reveals the next note to the right while the student is asked to read the score as “Left”, “Right” or “Both” to indicate whether they are to play with just the LH, just the RH or with BH. If they answer correctly, the system reveals one beat to the right to reveal the next note/s and the student once again has to say “Left”, “Right” or “Both”.

Through this technique, in which the students are taught to read the music on one level as “Both, Right, Left”, etc. the student becomes aware very quickly of which hand/s are required to play both on a general level and also in difficult spots where the music challenges the student's coordination, e.g. in rhythmical/syncopated pieces where the interaction between the two hands is complex.

Also the system implements a teaching/practicing method. Instead of the traditional approach of learning each hand separately from start to finish in a given piece, and then leaving the student to “practice with two hands for next week”, the system segments the music into bite-size chunks (usually one to two bars in length) and assists learning the Left Hand (LH) first, then the Right Hand (RH) and lastly Both Hands (BH) within that segment before permitting the student to move onto the next segment. This way the student quickly discovers their ability to play the piece with both hands straight away which builds their confidence.

But more than that, the system teaches children an effective systematic technique they can use to teach themselves any piece of music. It could be said that it teaches them how to practice. The reason this is so important is because most piano/keyboard students are never really taught how to practice, so between lessons, they are often developing inefficient and ineffective practice habits.

Our approach is superior to the usual scenario where students only learn separate hands in today's lesson and are then left to “practice with two hands at home for next week” because the traditional approach does nothing to assist the students to actually put the two hands together. By contrast, our approach teaches them how to make the most of their practice time rather than simply leaving students to their own devices until the next week's lesson.

Therefore one of the formulas of the Musiah™ teaching/practising method is: LH, RH, BH—one small segment at a time. Then repeat this process for each subsequent segment until the whole piece has been completed.

It should be noted that in the context of this specification a musical instrument is taken to include any means which could be used to produce music with and includes, without being limiting, musical instruments which produces music in a digital form or as sound waves, and the voice of a signer.

In the context of this specification answer is taken to mean any reply which a student submits as input to the learner terminal in response to an instruction given to the student by the processor device. Included into the understanding are answers, when the student is asked to select a correct option or asked to type in a correct answer, and segments of music played on the musical instrument.

Also in the context of this specification instruction is meant to include and oral, visual or other request or instruction which the processor communicates to the student on the at least one output device. Included into this understanding is a visual indication, for example, on a screen in which the student is asked (either only visually, orally, or a combination of both) to select a correct note. Also included is an instruction for the student to play a part of whole piece of music.

The term assist is interpreted widely in this specification and is understood to mean providing guidance, information, instructions, support, affirmation and the like to the student.

### BRIEF DESCRIPTION OF THE DRAWINGS

In order for the invention to be more readily understood the invention will be described with reference to the accompanying drawings in which:

FIG. 1 is a schematic representation of a music education system according to the invention.

FIG. 2 is a flow chart of steps taken during a lesson which is conducted with the music education system.

FIG. 3 is a flow chart of an example of steps that could be taken during an analysis step taken by a processor device of the music education system.

FIG. 4 is a flow chart of steps taken during the operation of the music education system showing an example of a structure of learning a segment during a lesson.

### DESCRIPTION OF AN EMBODIMENT OF THE INVENTION

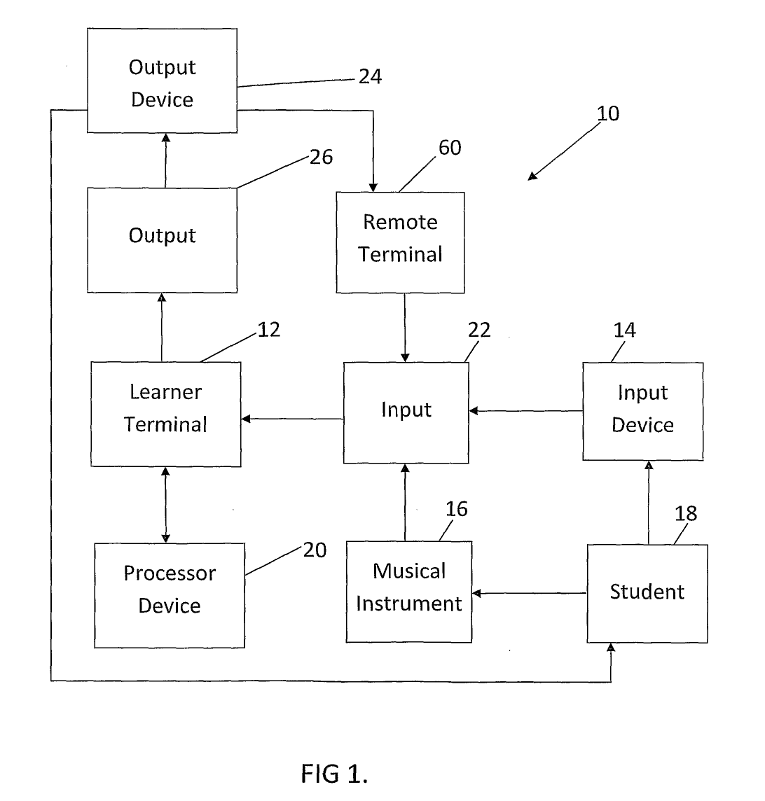

FIG. 1 of the accompanying representations illustrates a music education system 10 according to the invention. The system has a learner terminal 12 which contains one or more input devices 14 such a keyboard or a mouse, not shown, and a musical instrument 16 which a student wants to learn. The student terminal further has a processor device 20 which receives an input 22, either from one of the input devices or from the musical instrument, which is processed by the processor device. The student terminal also has one or more output devices 24, for example a speaker system or a visual display unit such as a screen, with which an output 26 generated by the processing device can be communicated to at least the student.

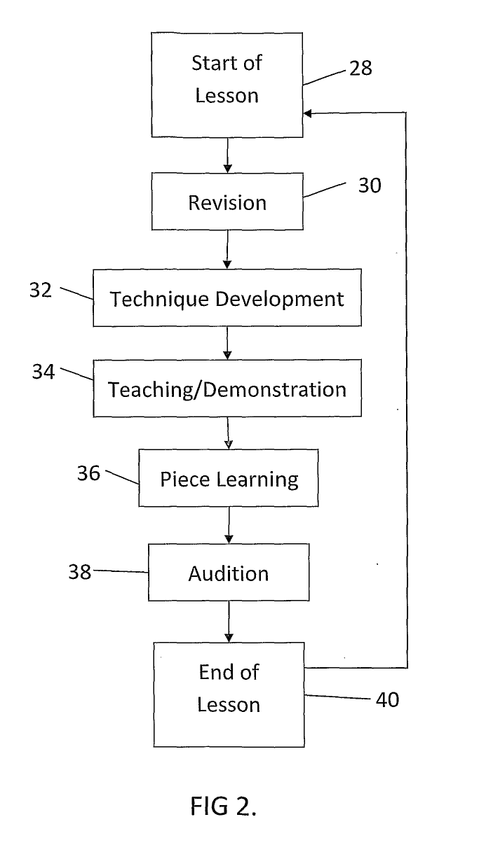

The music system 10 is divided into a lesson structure which allows the user to gradually improve with each lesson completed his or her skills with the musical instrument 16. An example of such a lesson structure is shown in FIG. 2 which shows possible steps which could be taken to make up the lesson. In the lesson example shown in FIG. 2 is started (28) by the student 18 whereafter the processor device 20 guides the student through various steps making up the lesson. Initially the student is asked to complete some revision exercises (30) which have been devised to generally improve the student's skill with the musical instrument. Typically these revision exercises will focus on activities such as symbol identification or matching and other suitable exercises which could improve the student's knowledge of the type of music played on the musical instrument.

The revision (30) is followed by technique development (32) which is specifically directed to improving the student's technique when playing the musical instrument 16. Suitable exercises used in developing technique may include reading of sheet material, rhythm exercise, etc.

The next step in the lesson is for the processor device 20 to demonstrate (34) some techniques and concepts which are related to the current piece of music being covered in the lesson. This step may be optional since the content covered herein could be covered in an earlier step of the lesson.

The particular piece of music covered by the lesson is next taught (36) to the student 18. In this step the piece of music covered in the lesson is divided into smaller sections or segments which should make it easier for the student to learn the particular piece of music. Typically the piece of music is divided into individual notes, for example with complex notes or tones, chords, or bars. Additionally, each segment can be further divided to include only left hand notes, only right hand notes, or both.

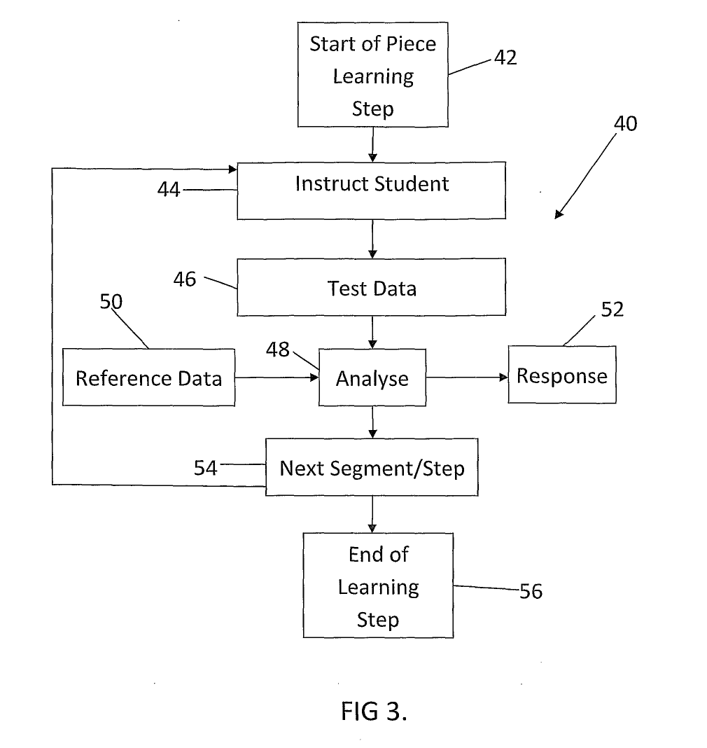

Once the student has passed the learning stage (36), the student 18 is asked to perform (38) the piece of music and when the piece is performed to a high enough standard the student is given the option to end the lesson (40) or to repeat the same lesson. In the example used in FIG. 2 the student is asked to “audition” the piece of music covered by the particular lesson. This task, i.e. auditioning, has been chosen to fit into the storyline which is being used to teach the student 18 the musical instrument 16. The music education system 10 has been devised, at least to some extent, to guide the learning process of the student 18 with the musical instrument 16. The processor device 20 is programmed with a set of rules and instructions which provides instructions to the student when learning the musical instrument. Ordinarily the skills of the student with the musical instrument will improve with practice as will the general knowledge of the body of music being played on the musical instrument. Included in this body of music are notes, note notations, pieces of music and the like. With this in mind the set of instructions and rules have been devised to guide the learning of the student over this wide field of musical information. Additionally, the rules and instructions will make allowance for the increase of skill and knowledge of the student as the student progresses with his or her learning curve. However, as will any music teacher will readily attest no two students are the same and consequently one student may take longer to master some aspects of the musical knowledge concerning the musical instrument than for another student. FIG. 3 shows an example of the logic which could be adopted during decision making in the music education system 10.

FIG. 3 is illustrated in the context of the piece learning step (36) shown in FIG. 2 but it is to be understood that the application of the logic applied in this step is used in the other steps as well (i.e. revision, technique development, teaching/demonstration an audition).

For simplification purposes the logic is generally referred to as a process step (40) which is meant to include, in the context of the example, the processor device 20 instructing or asking a question to the student using the at least one output device 24, receiving the answer from the student, processing the answer through analysis or comparison of the answer to a model answer, and based on the result of the process, selecting an appropriate output in which the student which assists the student in advancing his education of the musical instrument.

The steps shown in FIG. 3 include the process step (40). The student 18 commences the piece learning step (42) whereafter the processor device 20 instructs the student to play a segment of the piece of music being covered in the particular lesson (28). The student then inputs (component 22 in FIG. 1) as test data 46 his response into the learner terminal 12 for assessment or analysis (48) by the processor device 20. The processor draws reference data 50 particular to the lesson and segment and conducts a series of analytical questions during the processing of the test data in light of the reference data.

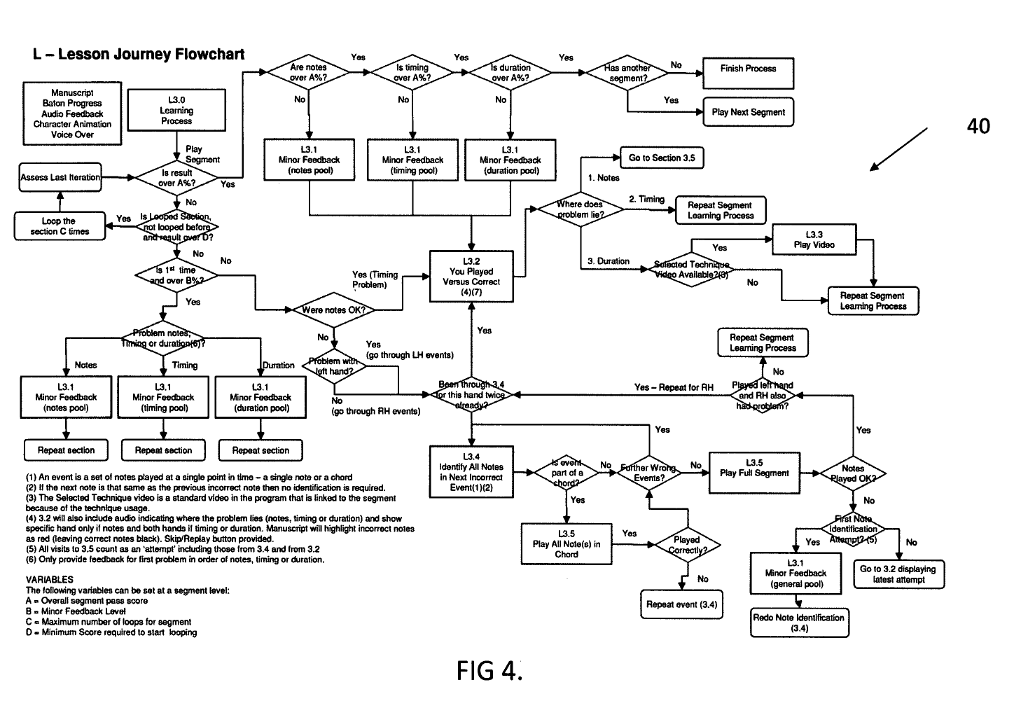

Referring to FIG. 4 there is shown detail of a Lesson Journey Flowchart in which:

(1) An event is a set of notes played at a single point in time—a single note or a chord
(2) If the next note is that same as the previous incorrect note then no identification is required.
(3) The Selected Technique video is a standard video in the program that is linked to the segment because of the technique usage.
(4) 3.2 will also include audio indicating where the problem lies (notes, timing or duration) and show specific hand only if notes and both hands if timing or duration. Manuscript will highlight incorrect notes as red (leaving correct notes black).

Skip/Replay button provided.

(5) All visits to 3.5 count as an ‘attempt’ including those from 3.4 and from 3.2
(6) Only provide feedback for first problem in order of notes, timing or duration.

Variables

The following variables can be set at a segment level:

A=Overall segment pass score

### B=Minor Feedback Level

C=Maximum number of loops for segment
D=Minimum Score required to start looping

An example of the analytical questions and reasoning are shown in FIG. 4 and are discussed in greater detail hereinafter. An appropriate output 26 as an answer or response 52 is selected during the analysis of the test data which is then communicated to the student 18 through the output device 24. When the student has submitted a satisfactory answer through the test data the student receives the next instruction (see step 44) until the learning step is completed (56).

An example of the possible analytical steps which can be taken during the analysis 48 step of the process step 40 is shown in FIG. 4. As explained hereinabove, the test data 46 compared against the reference data 50 and is scored for note, timing and duration accuracy using the scoring system. The predetermined percentage which the student should achieve to pass is 80% although this value could be adapted to allow for a number of different factors such as difficulty of the piece, age and demographic of the student. The student may also be awarded a number of stars depending on how well the student has scored. For example, the student may be awarded 1 star if he or she scored between 85% and 89%, two stars is the student scored between 90% and 94%, and three stars if the student scored between 95% and 100%. In the scoring system different weights are given to the importance of each piece. For example a beginner's piece might be Notes 50%, Timing 50% and Duration 0%. By contrast a more advanced piece might be Notes 40%, Timing 40% and Duration 20%. An example of possible note comparison follows.

Initial Note Comparison

Assuming that the student was instructed to play a number of notes in one segment, each note contained in the test data will be compared in against each of the notes contained in the ‘correct answer’ reference data. The two notes that match the closest (using a combination of note played and the time it was played at) are linked together and given a score. Currently, the scoring algorithm is as follows:

1. The note starts with a score of 0 out of a possible resulting 100.
2. Points are added for note accuracy (playing a C4 when a C4 was required for example). By default this is worth 60/100 points for the note, and can be adjusted. The greater the difference between the two notes being compared will result in loss of a certain number of points, defaulting to 20 points. For example if the note is C4, then a C4 is awarded 60 points, a B3 (one semitone below) or a C#4 (one semitone above) is awarded 40 points, an A#3 (two semitones below) or a D4 (two semitones above) is awarded 20 points and any other note is awarded 0.
3. Points are then added for timing (playing a note at the correct time). By default this is worth 20/100 points, and can be adjusted. For every 0.1 second that the note timing is off, the student 18 loses a default of 3 points. For example a note that is 0.2 seconds adrift is awarded 14 points.
4. Points are then added for note duration (how long the note is held). By default this is worth 20/100 points, and can be adjusted. For every 0.1 seconds that the note is long or short, the student loses a default of 3 points. For example if a note that should be held for 0.8 seconds is held for 0.9 seconds, it is awarded 17 points.

Processing the List

Extra handling is included in order to prevent two notes from being linked to a single reference note (in order to catch mistakes where the student has hit a note twice in rapid succession). Occasionally it will be the case that a better match for an already linked note is found; this is possible, for example, if the student has played the correct note but played it twice, once slightly early and once slightly late. When this happens the old link between notes will be removed, a new link added as appropriate, and the old student message will be added to a list to be re-evaluated and linked again if possible.

Determining Final Score

Once all the test data from the student have been evaluated, the two lists of notes (student's test data notes and reference data notes) are checked and three different values are calculated:
Matched notes (student notes that found a matching template note)
Extra notes (played by the student which were not required),
Missed notes (notes from the template that the student did not play).

These values are added together to get a Total Notes value. Then the score associated with every note played by the student is added together, and divided by the Total Notes value to provide an average that penalises the student for playing extra notes.

Breaking the Revision into Sections

If the piece was not passed successfully (by reaching 80% accuracy), a list is created of sections of the piece that the student must revise. These sections are used to determine what the student must practice. Each section is run through the scoring process again twice, separately from the other sections in the revision, once to determine the score of the left hand and then again to determine the score of the right hand. If that particular section/hand score is less than 80, it is added to a list of sections that the student must practice. Most of the time they must firstly use just the hand that failed, and then another time using both hands. It is possible that the entire piece is set up to be played with one hand however, in which case they will only be required to play again using that hand.

Referring to FIG. 1, the learner terminal 12 has an output device 24 which allows the learner terminal to communicate over a network, such as a wire or wireless network, with a remote terminal 60. Information as output which can be sent to the remote terminal as output 26 is progress data of the student's performance thus far using the music education system. This progress data can be used by a processor device of the remote terminal or an invigilator or musical teacher to alter the instructions and other content used to instruct the student 18 with. Input 22 is then communicated to the learner terminal so that the questions asked or instructions given to the student is adapted or changed. The input is typically communicated to the learner terminal using the same communications network as was used to send the progress data as output to the remote terminal.

The music education system 10 may include a step, or final steps at predefined stages at which the student 18 may be asked to perform a piece of music which was covered in a lesson, or series of lessons forming part of the musical education system. These performances can be recorded and submitted as output to the remote terminal for review. The approval will be made by the site administrators who will make their judgement within a week. If the student passes they might be accredited in any appropriate way, for example gaining the rank of Musiah, and receive a certificate by email. If they fail, they will receive feedback on their composition and be asked to try again.

According to the invention there is provided a system to offer students at home virtual group keyboard music lessons in the world's first virtual keyboard/piano lesson environment. The attention level offered is one-on-one just like having your own teacher on call 24 hours a day 7 days a week but the learning takes place and/or the songs are played with virtual friends/fellow students on the computer screen.

The system of the invention is a true virtual piano/keyboard teacher product/service/application. The system's virtual lessons provide true interactivity and not just the ability to press the pause button during a video lesson. Students will have a musical midi format keyboard connected to their computer and our virtual keyboard teacher of the system of the invention monitors every note played by the student and gives them continuous feedback and guidance on how they're going and what they need to do to improve—just like a real piano/keyboard teacher.

Also there can be virtual group lessons and not just solo lessons. Many of the pieces provided are ensemble pieces allowing the student to play their part, whilst the virtual characters/fellow students on the screen play the other parts at the same time. The virtual friends/fellow students on the screen are aliens (i.e. children from other planets).

The system of the invention is a real lesson course with a real school of music. While lessons run mostly on the student's computer, to access the lessons the student is required to log on periodically via the internet. This enables the system to track each student's progress using an online database and tailor lesson content as required. With any other video piano/keyboard lesson course/software package, once the product is sold there is no active monitoring/ongoing adaptation of material to meet students' needs. With this system, if students are experiencing difficulty at a particular point in the course, this is picked up and addressed by modifying the lesson content. All changes/updates to the lesson content are downloaded to the students' computer each time they log on.

The system of the invention's virtual keyboard lessons have a unique sub-plot/storyline that runs between the lessons thereby creating a highly original game-like environment to engage children in a sustained, absorbing and uniquely creative way.

The system also provides unique teaching strategies. The child is constantly revising and learning to note read, play individual pieces accurately and is able to play in ensembles to learn to stay in time and synchronized with other members but also as a form of encouragement. The assessment allows an accurate description of the child's progress, in particular the ability to pinpoint the inaccuracies of the child's playing.

The Musiah™ Method is a unique form of teaching. Traditionally, the child spends one lesson learning to practice the whole piece of music in separate hands. They must then independently attempt to learn playing with both hands for the lesson the following week. The unique method utilized by the program is to segment the music from 1 to 2 bars in length. The child learns the right hand and left hand notation first followed by both hands within the segment before permitting the student to move onto the next segment. This allows the student to effectively learn to play with both hands whilst building their confidence and encouraging them to continue with the next segment. This method is repeated for each subsequent segment until the whole piece has been completed.

In addition, the invention illustrates several techniques that aid a child in learning how to begin playing an instrument with both hands. Particularly in complex pieces, the invention teaches students to read the sheet music as “both,” “left” and “right” to indicate whether they are to play with the left hand, right hand or both hands. If they answer correctly then the next note is revealed to the student whom must again answer “left,” “right” or “both.”

Storyline Example

In one example of The Creative Concept of the system of the invention, the virtual keyboard teacher or professor is Musiah Fandango™ who is Planet Zircon's foremost living composer. He and his son ‘Scratch Fandango’ are on an adventure to find “The Lost Song” which was written by a mysterious unidentified composer, said to be the greatest composer the universe has ever known. Whoever discovers the Lost Song will be invited to perform the Lost Song in a prestigious Inter-Galactic concert and if they complete this challenge successfully, they will be awarded Planet Zircon's highest honour—the rank/title of “Musiah™”—the term denotes the highest level of professorship/musical skill and knowledge combined with great wisdom and spiritual awareness and is sometimes accompanied by special powers. In other words, a system of the invention is the musical equivalent of a Jedi™ knight.

The System of the Invention and Scratch communicate with the student by “live transmission” from their spaceship hovering somewhere over earth as they cannot survive in the Earth's atmosphere, which is why they need the help of someone from earth. Additionally, to find the Lost Song, the earth student must use a device called a transponder to detect clues to the location of the Lost Song, but the transponder will only work in the hands of someone musical, which is why the earth student must learn to play the keyboard/piano.

As the student learns each piece from the textbook, they receive awards which are displayed on their progress page. Every time five pieces have been completed, the student is “beamed” to another location on earth where they use the transponder to find the next clue to the location of the Lost Song. This takes place by way of animated sequences between lessons.

The course is also divided into various levels. As they complete each level the student is awarded a higher rank and they will receive (by email/download) a certificate, signed by Musiah Fandango™.

Eventually, the student progresses to the end of the course where The Lost Song and the identity of its composer are revealed, and the student is invited to perform the Lost Song (a great challenge). If successful, the student will be awarded a completion rank/title with the top rank of “Musiah™”

Group Lessons

The system of the invention and other animated characters on the screen simulate a group keyboard music lesson environment. To assist with the teaching process, sometimes the system of the invention's questions are directed at the virtual students in the group so the ‘earth” student can hear how the other students answer. For questions that are directed at the earth student, the student is required to click from a range of possible answers on the screen or to play something on their midi keyboard which is connected to the USB socket on their computer. Everything they play on their midi keyboard is recorded as midi data and assessed using various algorithms. The animated characters then provide feedback/guidance in a very natural human-like way. Put simply, every possible response/non-response from the student has been anticipated in minute detail and for every response from the student; The System of the Invention is programmed to respond in turn.

Lesson Structure

Lessons are comprised of the following key components:
A Task is where the student is required to do something that under normal circumstances can only be done correctly or incorrectly.
A Game is a series of tasks for which the student receives a score of 10 points for each correctly completed task or loses 10 points for each incorrectly completed task. To complete the game, the student must attain a score of 100 points.
A Piece is where the student is required to play all or part of a piece during which the application will assess continuously providing a score out of 100 afterwards. (Continuous assessment is not required during a task because a task can only be done correctly/incorrectly).
A Score. During the assessment of each piece (the audition process), each bar is given a score out of 100 (The weighting of the score can vary from piece to piece, but as an example may be 40% for accuracy of notes, 40% for timing and 20% for duration of notes). The score that the student receives at the end of the piece is the average of the scores from all the bars. However, regardless of the overall score, the student will only be permitted to move on to the next task/piece if they can play the piece all the way through and every bar has a score of 80% or more. Using this approach (if a piece requires more work), The system of the invention can ask the student to work on the specific bars that most need attention rather than vaguely asking the student to practice the piece again with no specific direction/guidance.

Example Lesson

In an example of the system of the invention, (with other virtual students looking on) the virtual teacher would open up a piece of music from the textbook (the next page after the student's most recently completed piece) and begin with revision. Revision would usually consist of a Note Reading Game where the system of the invention points to/highlights a series of notes on the sheet music and asking the student to identify them by clicking matching notes on a chart or choosing from a range of possible answers with a mouse click. Depending on the context, the game may involve giving the student a score. Throughout the revision, if the student answers incorrectly the system's response would be randomly chosen from a series of possible responses such as “ah ah, not quite, no . . . try again, etc.” If the student answers correctly, the system of the invention's response would be also randomly chosen from a series of possible responses such as, “yes, well done, very good, that's right, etc.” In this way, the system of the invention's response will seem as life-like and as personalised as possible.

The system of the invention explains any new concepts/challenges/points out anything unusual on the page and outlines the first few steps the student must complete in order to begin learning the piece. Typically, the explanation would be something like, “OK, the one new thing on this piece is the note B . . . can you play me this note on the keyboard?” If the student plays it correctly, the system of the invention says “very good, etc” if the kid plays it incorrectly, a keyboard would appear on the screen and the system of the invention would say, “what you played is this (pointing to/highlighting the incorrect key), the correct key is this (pointing to/highlighting the correct key).

Typically in The Learning Process, students will be required to learn each piece by taking a small segment (such as 1-2 bars) and learning the left hand (LH) then the right hand (RH) then both hands (BH) within that segment. They must complete this to a reasonable standard before proceeding to the next segment. In the virtual lesson, the system of the invention would allocate one task at a time which the student is required to complete. If the student does it badly/incorrectly, the program will play back to the student what they played and then play it for them the correct way and ask the student to try it again. This is how the bulk of the lesson would proceed.

### Example

1. The system of the invention says, “OK, first we're going to learn the left hand notes just in these two bars (highlighting the required notes)”. First task: “Play me the first note” (how the system of the invention responds is with a standard positive “yes” response, or “try again” response. If the student gets it wrong 3 times, the system of the invention will demonstrate).
2. Second task: “And the next note (highlighting the note)” (this phrase is chosen randomly from a series of possible “next note” phrases, e.g. “and this one, now this one, next one, etc.” . . . . The system of the invention responds positively or negatively as before.
3. Third task: “Next one” (from the list of “next note phrases” with the same possible positive/negative responses from the system of the invention depending on whether the student plays it correctly. Once the student has gone through the segment with the LH one note at a time, the system of the invention will ask them to play the LH from the start to the end of the segment and depending on the accuracy will give guidance/responses from a pre-determined list of phrases.
4. Next the student will go through the RH and then BH just in that segment before advancing to subsequent segments.

In the Group Part of the Lesson, when the student has completed all segments BH, The System of the Invention will ask them to play through the whole piece without stopping. If the piece contains more than one part and if the student is sufficiently accomplished on his/her part, the system of the invention might ask Scratch and/or some of the other virtual students to play part the other parts while the student plays Part 1.

Example Assessment:

Sample Lesson Dialogue:

Intro: OK, so now you've complete Page 1, you've only got 4 more songs to learn to receive your Transponder—the critical device which you'll need to find the clues that will lead you to the location of the lost song.

Before we begin, let's do a little revision. Scratch will you empty your satchel please. Scratch empties his satchel on the floor and the system of the invention picks up each item in random order asking the student to identify them from a range of possible answers as follows:

Revision Game:

A score of 0 is displayed. The student must identify 10 items in a row correctly to get a score of 100 (10 points per item) before the game is finished.

The system of the invention: What's this (holding up a randomly selected item)? (possible answers are Treble Clef, Right Hand, Long Note, Short Note, Middle C, i.e. all knowledge gathered so far).

If correct answer: (randomly select responses from)

“yes, and this”, “well done . . . and this . . . ”, “good, and this . . . ” (until the last item has been correctly identified . . . “very good”) score increases by 10 points

If incorrect answer: (randomly select responses from this),

“uh uh, try again”, “not quite”, “nearly”, “come on, have another go”

score decreases by 10 points but never goes below 0.

Once a score of 100 has been obtained, applause sounds.

Task: OK, before we begin the 2nd song, we're going to learn how to find G on the keyboard with each hand. Ready Scratch? (Scratch says Yep).

With my RH in C position, if my thumb is on C, then G is this key over here where my pinky is. (The system of the invention demonstrates RH C, then G)

In my LH, if my pinky is on C, then G is over here on the other side of my hand where my thumb is. (Scratch says . . . “So in either hand, if you know where C is, G is on the opposite side of your hand.”) Exactly.

Game: (as before, a score of 0 displays . . . each correct response gets 10 points, each incorrect responses decreases the score by 10 points but never below 0 . . . a score of 100 completes the game)

The system of the invention: So let's play a quick game of the system of the invention says . . . you too Scratch (screen view changes to show side view of scratch) . . . . The system of the invention says, hands on laps. The system of the invention says . . . put BH in C position . . . Go. OK, Scratch has got it. XXX, to show me if you've got it, the system of the invention says, play C with (BH)

Possible Responses: (various)

Overview

The system of the invention therefore provides a virtual group keyboard lessons, virtual group piano lessons, virtual keyboard lessons, virtual piano lessons, online piano lessons, online keyboard lessons, internet keyboard lessons, internet piano lessons, virtual piano teacher, virtual piano school, virtual keyboard teacher, virtual keyboard school.

The areas of inaccuracy and/or difficulties that the invention overcomes include:
Limited or no interactivity on current products, e.g. video lessons.
Inability to monitor what students are playing and provide feedback and guidance during each lesson
Inability to track student progress after product design is complete to assess product effectiveness in the field and to modify course content as required.
Solitary aspect of learning an instrument (we provide virtual friends with loads of personality).
Lack of motivational tools to keep students interested
Lack of entertainment—other products which the applicant are aware off are dull video style presentations of mostly elderly people sitting alone at their instrument—not very exciting for children
Poor standard of teaching offered by unqualified individuals. Our syllabus is a recognized program already offered in hundreds of primary schools throughout Australia.

Therefore the improvements/advantages of the invention over any current products or methods include:
High level of interaction with students clicking answers on screen or playing on midi keyboard
Ability to monitor (by recording midi data) what students are playing and provide feedback and guidance during each lesson by anticipating every possible student response and guiding accordingly.
Ability to track student progress after product design is complete to assess product effectiveness in the field and to modify course content as required. We track length of time not only to complete each lesson but to complete each task within each lesson and record this information on our online database. Students who are taking a long time to complete a particular task/group of tasks may be offered alternative lesson versions to suit their needs. E.g. if their note reading is weak, this can be emphasized by way of extra revision.
Our virtual characters make these lessons feel like the student is part of a group interacting with and playing with others thereby removing the solitary aspect often associated with traditional private lessons as well as with various current video style lessons currently available. Additionally we are able to offer the same level of attention as a one-on-one teacher when compared with live group lessons where the teacher would have to spend time attending to the needs of other students in the group. So the attention level the student receives is like that of a private lesson, while simultaneously receiving the benefits of a group lesson.
Motivational tools to keep students interested. Every time a student completes one of our pieces they receive a trumpet fanfare, a sticker (now it is currency) on their individual virtual progress page, bonus points partly for how well they've finished each piece and partly for the length of time taken to complete each piece. These bonus points are cumulative as the student progresses through the course. With our online database we are also able to give students an indication of how well they are progressing compared to other students (e.g. we can indicate that a student is the most advanced in their country/state/suburb/street/school/household as appropriate). Also we provide bigger rewards for completing five pieces . . . the student gets to use a transponder to find clues to the location of the lost song. And as the student completes each level they are awarded a higher rank, the ultimate rank being that of the system of the invention.
Entertainment—our animated characters are highly entertaining and original. Also our unique sub-plot provides a stimulating scenario whereby the student is on an adventure together with the animated characters to discover the location of the Lost Song.
Use of Games within our lessons: Our lessons include games, humour and a positive emphasis on the value of knowledge. Consider for example our approach to revision: At the end of each piece, the student is required to gather up all the knowledge learnt in that piece by clicking on the highlighted items with their mouse. As they click each item, Scratch picks them up and puts them in his satchel where they can be reviewed later. At the start of the next lesson Scratch empties his satchel on the floor and the virtual teacher or professor randomly selects previously learnt items of knowledge from the pile and asks the student to identify them. The student must identify 10 items in a row correctly to get a score of 100 (10 points per item) to complete the game. Once a score of 100 has been obtained, applause sounds.
Poor standard of teaching offered by unqualified individuals. Our syllabus is a recognized program already offered in hundreds of primary schools throughout Australia.

While we have described herein a particular embodiment of a music education system, it is further envisaged that other embodiments of the invention could exhibit any number and combination of any one of the features previously described. However, it is to be understood that any variations and modifications can be made without departing from the spirit and scope thereof.

1-57. (canceled)

58. A music education system including a learner terminal through which a student is capable of learning to play a musical instrument;
the learner terminal includes:
at least one input device with which the student is capable of generating test data;
a processor device which is capable of receiving the test data from the student; and
at least one output device with which the processor device is capable of communicating with the student;
wherein the processor device automatically undertakes analysis of the test data relative to at least a portion of a reference data accessible to the processor device; and
wherein the analysis of the test data allows the processor device to select an appropriate response which is communicated to the student as output through the at least one output device to assist the student in learning how to play the musical instrument.

59. A music education system according to claim 58 wherein the learner terminal is integrally formed with the musical instrument and wherein the at least one of the peripheral devices are connected directly to the learner terminal.

60. A music education system according to claim 58 wherein the at least one input device includes at least one peripheral device and a musical instrument; and wherein the at least one peripheral device is selected from any one or a combination of the following: a keyboard, a mouse, a touch screen, and a voice recognition device; and
wherein the at least one output device is at least one peripheral device which is selected from any one or a combination of the following: a visual display, and a sound generating device.

61. A method for guiding a student to learn how to play a musical instrument on a digital device, the method including the steps of
a. providing on the digital device at least one instruction relating to the musical instrument for the student;
b. receiving test data from the student;
c. processing with the digital device the test data received from the student;
d. analysing the test data in relation to at least part of a reference data and comparing the current state to the goal state, and dividing the difference between them into subgoals in order to achieve the goal state;
e. selecting with the digital device a response output based on the analysis of the test data so that the student is assisted in learning how to play the musical instrument; and
f. automatically providing an response output which is accessible to the student.

62. A method according to claim 61 which includes the steps during the analysis of the test data of
a. assigning an accuracy value to the test data in comparison to the corresponding portion in the reference data, and
b. using the value to adjust the response output including a response from a pooled library of responses and an alteration of further instructions.

63. A method according to claim 62 wherein the assessed accuracy value is derived from an assessment based within ranges together with an assessment determined by an algorithm to provide a pseudo subjective assessment.

64. A music education system according to claim 58 for use on a digital means which is capable of receiving an input from a student for analysis by the digital means to provide an output as a result of the analysis; the system provides a set of instructions to a student learning a musical instrument; and wherein upon receiving an input from the student the digital means automatically analyses the input thereby to provide further instructions to student as guidance in learning how to play the musical instrument and wherein the comparison is between the received input and a software generated version of the music or a pre-recorded actual stored version of the music and compares the current state to the goal state, and the difference between them is divided up into subgoals in order to achieve the goal state and wherein the comparison is between the received input and a software generated version of the music or a pre-recorded actual stored version of the music.

65. A music education system according to claim 64 wherein the comparison includes an analysis of the provided set of instructions and the received input.

66. A music education system according to claim 64 wherein the automatic review includes a comparison of the received musical input and digitally compares it to the expected musical input thereby providing an analysis based on any one or more of the following predetermined criteria:
a. assessed accuracy of notes played;
b. assessed accuracy of timing of notes;
c. assessed accuracy of duration of notes;
d. assessed accuracy of timbre;
e. depth of resonance;
f. overall assessed accuracy; or
g. assessed accuracy of specific portion of piece.
wherein the assessed accuracy value is derived from an assessment based within ranges together with an assessment determined by an algorithm to provide a pseudo subjective assessment.

67. A music education system according to claim 66 wherein the automatic review is an objective assessment between the input from the student and a feedback from a library of pre-recorded feedbacks whereby the assessment is undertaken in comparison to a musical result and not merely a mathematical result.

68. A music education system according to claim 67 wherein the structure of the learning program provides a lesson in accordance with:
a) predefined teaching technique of a defined topic;
b) predefined teaching technique to remedy a detected flaw; and
c) predefined teaching technique to improve development.

69. A music education system according to claim 64 wherein the learning program provides a lesson structure by use of a virtual instructor in the output as a teacher or professor that introduces, corrects and advises on the scheduling and comparison.

70. A music education system according to claim 64 wherein to define a pathway of the learning program a corresponding storyline is involved and displayed alongside the music instructions and review.

71. A music education system according to claim 64 wherein the music instructions of the learning program and review are intertwined by relevance to the virtual instructor as a teacher or professor.

72. A music education system according to claim 64 wherein the music instructions of the learning program at any particular level or lesson can include a particular chapter or section of a corresponding story whereby a student's pre-existing skill in understanding the progress of a storyline provides the benefit of allowing an awareness of musical progress. and wherein the music instructions of the learning program at any particular level or lesson includes a virtual game approach setting goals corresponding to shown achievement of musical goals.

73. A music education system according to claim 64 wherein there is a means of combining input from the student with input from one or more virtual inputs in sequenced timing from an online connection.

74. A music education system according to claim 64 wherein the learning program provides teaching of group playing by visually displaying and providing virtual group lessons by simulating with virtual characters other parts of the music.

75. A music education system according to claim 64 wherein the learning program provides a graduated learning program that includes a corresponding graduated virtual storyline game.

76. A music education system according to claim 64 wherein the review can include simulated communication with the instructor by communication from a virtual teacher or professor and the virtual teacher or professor provides output to the student including:
a. providing explanations of concepts before level begins;
b. providing positive comments whilst playing
c. providing continual guidance by pointing to where the child is up to in the sheet music with a moving baton;
d. providing details of simulated story and goals to be achieved;
e. providing instructional comments and feedback on how to correct or improve performance.

77. A music education system according to claim 64 wherein there is provided an output of a unique new teaching method of Left Hand (LH), then Right Hand (RH), then Both Hands (BH) in one small segment of music at a time and then repeating this process for each subsequent segment until the whole piece has been completed, wherein the music education system using a reveal technique to show how both hands fit together whereby the output has a display showing the music but covers the notes on the sheet music and gradually reveals the next note or musical event to the right while the student is asked to read the score as “Left”, “Right” or “Both” to indicate whether they are to play with just the LH, just the RH or with BH; if they answer correctly, the system reveals one step to the right to reveal the next note/s and the student once again has to indicate “Left”, “Right” or “Both”; whereby the student becomes aware of which hand/s are required to play. and wherein the system implements a teaching/practicing method wherein the system segments the music into bite-size chunks (usually one to two bars in length) and assists learning the Left Hand (LH) first, then the Right Hand (RH) and lastly Both Hands (BH) within that segment before permitting the student to move onto the next segment.
